(19) United States
(12) Patent Application Publication
(10) Pub. No.: US 2008/0066320 A1
(43) Pub. Date: Mar. 20, 2008

(54) Flooring Material Cutting Device

(76) Inventors: Dewey R. Delaney SR., Knoxville, TN (US); Bruce Romines, Knoxville, TN (US)

Correspondence Address: LUEDEKA, NEELY & GRAHAM, P.C., P O BOX 1871, KNOXVILLE, TN, 37901, US

(21) Appl. No.: 11/945,660

(22) Filed: Nov. 27, 2007

Related U.S. Application Data
(62) Division of application No. 11/155,697, filed on Jun. 17, 2005.

(51) Int. Cl. B26B 29/00

(52) U.S. Cl. 30/294

(57) ABSTRACT

A flooring material cutting device adapted to cut flooring material to fit around a door frame having a given geometry. The flooring material cutting device is comprised of a blade formed from a sharpened segment of material having the given geometry wherein the blade is adapted to cut the flooring material. The flooring material cutting device is further comprised of a blade box adapted to securely hold the blade relative to the flooring material. In addition, the flooring material cutting device is comprised of a cutting assembly adapted to engage the flooring material against the blade, thereby cutting the flooring material.

### CROSS REFERENCES TO RELATED APPLICATIONS

This patent application is a divisional of co-pending application Ser. No. 11/155,697, filed on Jun. 17, 2005, entitled “FLOORING MATERIAL CUTTING DEVICE”.

### FIELD

The present invention relates to the field cutting flooring material such as carpet, tile and vinyl composition tile.

### BACKGROUND

Industrial and commercial buildings have many doors. Most of these doors are encased in an industrial, standardized door frame. When the buildings are constructed, door frames are permanently placed well before any flooring material is laid down. Near the end of construction, or at any time when flooring material is replaced, the flooring material needs to be custom fit around each door frame.

The current manner of placing flooring material is very time consuming, not very precise, and might be dangerous. A flooring job takes a lot of time to complete and may produce an unsightly finished product. At present, in order to place a flooring material around a standard door frame, an installer must take multiple measurements around the door frame, in two dimensions, and transfer these measurements by drawing the measurements on the flooring material using a pencil or some other writing instrument. Once the measurements have been drawn on the flooring material, it is then heated to make it more pliable. The hot material is then cut along the transferred measurements with some type of razor or knife. Handling a heated piece of flooring material with one hand and a sharp, exposed blade with the other is dangerous and can lead to injuries to the installer, either by burns, cuts, or both.

As can be appreciated, the cuts made in this manner may not be very precise and are very time consuming. It is very difficult to accurately transfer the measurements taken on the floor around the door frame to the flooring material. The inherent imprecision often results in a cut piece of flooring material that does not fit very well around the door frame. The corners of these cuts may have sharp angles that do not exactly abut the rounded edges of a door frame. The resulting gaps between the door frame and the poorly fitting piece of flooring material must then be caulked. The caulking around the door gives a messy and unsightly appearance. In addition, if the cuts do not completely remove the measurement markings placed on the flooring, those remaining markings contribute to the messy appearance of the floor. What is needed is a device which allows an installer to safely, quickly and precisely cut flooring material to fit around door frames.

### SUMMARY OF THE EMBODIMENTS

The above and other needs are met by a flooring material cutting device. The flooring material cutting device is adapted to cut flooring material to fit around a door frame having a given geometry. The flooring material cutting device is comprised of a blade formed from a sharpened segment of material having the given geometry wherein the blade is adapted to cut the flooring material. The flooring material cutting device is further comprised of a blade box adapted to securely hold the blade relative to the flooring material. In addition the flooring material cutting device is comprised of a cutting assembly adapted to engage the flooring material against the blade, thereby cutting the flooring material. In one embodiment of the invention, the device has a frame box for structurally supporting the blade box, measuring devices and a finish trimmer.

In another embodiment of the invention, the flooring material cutting device is made to be more easily transportable. In this embodiment, the blade box is attached to a handle, to create a hand-held cutting device.

The blade box cuts out the shape of a door frame from a piece of flooring material in a single cut. Thus, the operator does not have to hold a heated piece of flooring material in one hand, while using an exposed blade to cut it in the other, reducing the chance that the operator will be burned, cut or both. Because the blade box cuts the shape of the door frame into a piece of flooring material in a single cut, significant time is saved over the old method of making multiple cuts. In addition, the operator does not have to transfer the dimensions of the area to be cut onto the piece of flooring material before it is placed in the flooring material cutting device, thereby reducing the unsightly appearance of lines drawn onto the flooring material. Further, because the blade box is designed to accurately replicate the geometry of the door frame, the flooring material which it cuts fits around a door frame very neatly, without having to add additional unsightly caulking. Thus, the use of the flooring material cutting device saves time, reduces the chance for injury on the work site and provides a more slightly finished flooring project. The flooring material cutting device is adapted to cut tiled flooring material as well as flooring material provided in sheets. The flooring material cutting device cuts carpet as well as vinyl composition tile.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements thorough out the several views and wherein:

FIG. 1 is a drawing of a flooring material cutting device, from a first angle;

FIG. 2 is a drawing of a flooring material cutting device, from a second angle;

FIG. 3 is a drawing of a flooring material cutting device, from a third angle;

FIG. 4 is a drawing of a flooring material cutting device, from a fourth angle;

FIG. 5 is a drawing of a flooring material cutting device attachable finish trimmer from a first angle;

FIG. 6 is a drawing of a flooring material cutting device attachable finish trimmer from a second angle; and,

FIG. 7 is a drawing of a hand-held cutting device.

### DETAILED DESCRIPTION

The present invention relates to a flooring material cutting device 20 for cutting flooring material to fit around door frames, such as standard commercial door frames.

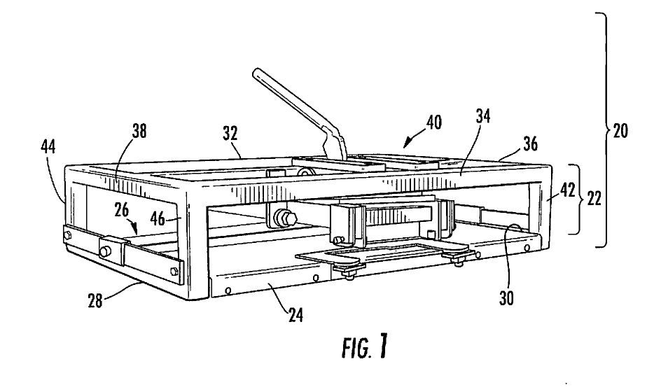

FIG. 1 is a drawing of the preferred embodiment of flooring material cutting device 20. The device contains frame box 22, which is made up of bottom front 24, back 26, left 28 and right 30 bars, top back 32, front 34, right 36 and left 38 bars, as well as right back 40 and front 42 vertical bars and left back 44 and front bars 46. The frame box 22 provides structural support for the remaining elements of the device 20.

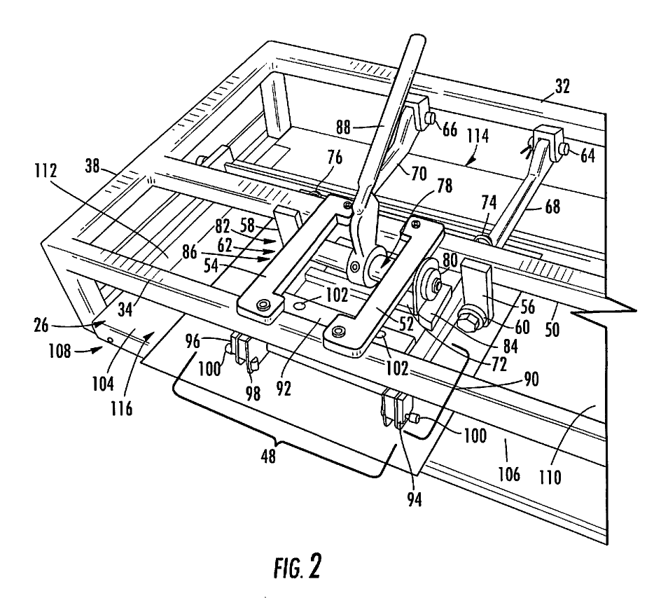

FIG. 2 is a drawing of cutting assembly 48. Cutting assembly 48 includes a center support bar 50. Center support bar 50 is attached to the top right bar 36 and top left bar 38, so that it is parallel to top front and back bars 32 and 34. Right and left sleeve bearing surface brackets 52 and 54 are attached to the center support bar 50 and the top front bar 34.

Depending from the center support bar 50 are right and left support brackets 56 and 58. Right and left guide bearings 60 and 62 are attached to the right and left support brackets 56 and 58, respectively.

Right and left pivot pins, 64 and 66, are attached to the top back bar 32 of the frame box 22. Right and left blade box arms 68 and 70 are pivotally attached to the right and left pivot pins 64 and 66. The right and left blade box arms 68 and 70 are parallel to the left and right top and bottom bars 28, 30, 36 and 38 of the frame box 22.

A cam roller bearing block 72 is attached perpendicularly between the right and left blade box arms 68 and 70. A right spring 74 is attached between the center support bar 50 and the right blade box arm 68. A corresponding left spring 76 is similarly attached between the center support bar 50 and the left blade box arm 70.

A cam 78 is located between the sleeve bearing brackets 52 and 54 and the cam roller bearing block 72. The cam 78 has right and left off-set bearings 80 and 82. The cam also has right and left sleeve bearings 84 and 86. A cam handle 88 is attached to the cam 78.

A blade box 90 is attached to the right and left blade box arms 68 and 70, parallel to the cam roller bearing block 72. The blade box 90 has a top blade box side 92, a right blade box side 94 and a left blade box side 96. The top 92, right 94 and left 96 blade box sides are attached together to form a receptacle for holding a blade 98. The blade 98 can be made from a sharpened segment of a door frame, from a segment of metal which has been formed to substantially correspond to the geometry of a door frame or from a piece of ceramic which has been formed to substantially correspond to the geometry of a door frame. The blade 98 is placed in the blade box 90 by blade attachments 100. A blade placement guide 102 can be provided in the top blade box side 92 to correctly position the blade 98 in the blade box 90.

A base panel 104 is attached to the frame box 22. The base panel 104 has a top side 106 and a bottom side 108, as well as right 110, left 112, back 114 and front 116 sides. The right side 110 of the base panel 104 attaches to the bottom right bar 28 of the frame box 22. The left side 112 of the base panel 104 attaches to the bottom left bar 30 of the frame box 22. The back and front sides 114 and 116 of the base panel 104 attach to the bottom back and front bars 24 and 26 of the frame box 22, respectively.

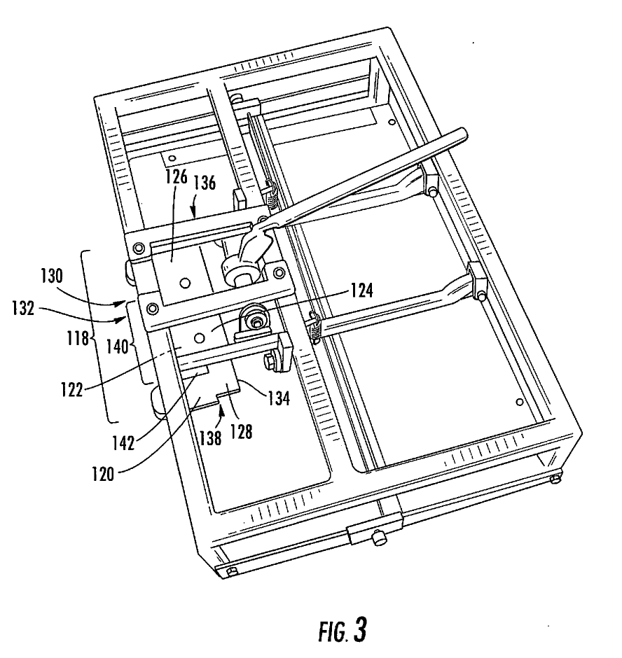

Referring now to FIG. 3, blade receiving mat 118 is located at the front side 116 of the base panel 104, beneath the blade box 90. The blade receiving mat 118 has a top layer 120. The top layer 120 has a top layer front side 122, top layer back side 124, top layer left side 126 and a top layer right side 128. In addition, the blade receiving mat 118 has a bottom layer 130. The bottom layer 130 has a bottom layer front side 132, a bottom layer back side 134, a bottom layer left side 136 and a bottom layer right side 138. The top layer front side 122 has a blade receiving portion 140 removed from it. The blade receiving portion 140 is sized and shaped to correspond to the dimensions of blade 100, such that when the blade 98 is engaged, it will not touch top layer 120.

The blade receiving mat 118 is attached to the flooring material cutting device 20 by placing the bottom panel 130 beneath base panel 104 so that the bottom layer front side 132 is oriented in the same direction as the base panel front side 116. Next a backing 142 is placed on the bottom layer 130. The top layer 120 is then placed over the backing 142, so that the top layer front side 122 is oriented in the same direction as the bottom layer front side 132. The blade receiving portion 140 of top layer 120 keeps the blade 98 from warping when it is in use.

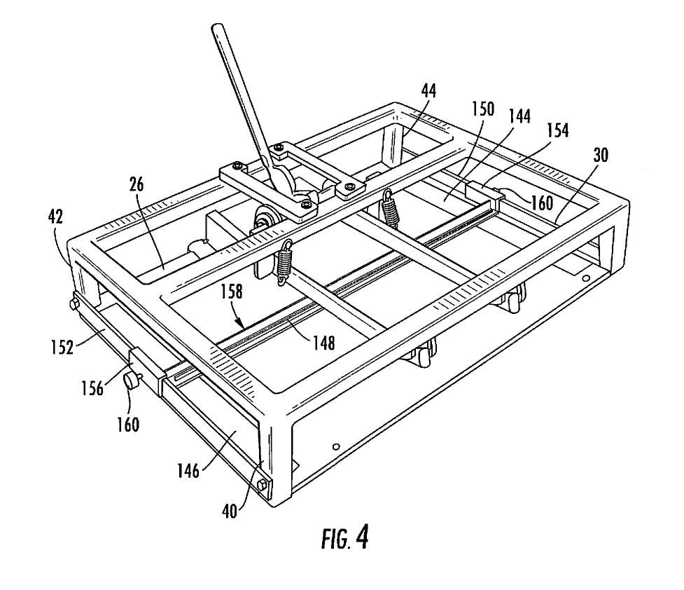

Referring now to FIG. 4, a left measuring device 144 and a right measuring device 146 is also provided. The left measuring device 144 is parallel to the bottom left bar 30. Similarly the right measuring device 146 is oriented so that it is parallel to the bottom right bar 28. Left measuring device 144 and right measuring device 146 are secondary measuring devices which can be used individually or in connection with an adjustable measuring device 148.

The adjustable measuring device 148 has a left side arm 150, a right side arm 152 and a central measuring device 158. The left side arm 150 is attached to the left front vertical bar 46 and the left back vertical bar 44 of the frame box 22, so that it is parallel to the bottom left bar 30. A right side arm 152 is attached to frame box 22 between the right front vertical bar 42 and the right back vertical bar 40. The right side arm 152 is parallel to the bottom right bar 28 of the frame box 22. A left side positioner 154 moves along the length of the left side arm 150. A right side positioner 156 moves along the length of the right side arm 152. A central measuring device 158 is attached to the left and right side positioners 154 and 156, so that the central measuring device 158 is parallel to the bottom back bar 24 and bottom front bar 26 of the frame box 22. The central measuring device 158 can be positioned toward the back side 114 or front side 116 of the base panel 104 or anywhere in between. The central measuring device 158 is positioned by moving the left and right side positioners 154 and 156 along the left and right side arms 154 and 152. The left and right side positioners 154 and 152 can be fixed in place with locking devices 160.

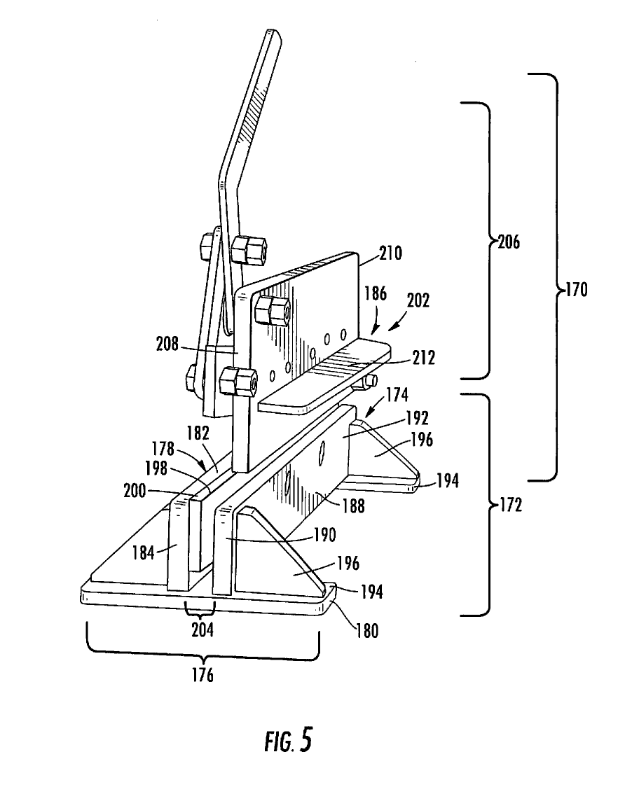

Referring to FIG. 5, in a further embodiment, an attachable finish trimmer 170 can be attached to the frame box 22 for completing any partial cuts. The finish trimmer 170 is comprised of a lower blade base 172. The lower blade base 172 is comprised of a lower blade base back side 174, a lower blade base front side 176, a lower blade base top side 178 and a lower blade base bottom side 180. The lower blade base 172 is further comprised of a left arm 182. The left arm 182 has a front 184 and a back 186. Parallel to the left arm 182, the lower blade base has a right arm 188. The right arm 188 has a front 190 and a back 192.

Feet 194 are attached to the bottom 180 of the lower blade base 172 hold the finish trimmer 170 steady while it is in use. Additionally, stabilizers 196 are attached between the feet 194 and the left and right arms, 182 and 188, to keep the finish trimmer 170 from warping while force is being exerted upon it.

The left and right arms, 182 and 188, as well as the feet 194 and stabilizers 196 are made from a sturdy material such as steel. The left and right arms, 182 and 188, are attached to the feet 194 by bolts, screws, welding or other ways known to the trade. The stabilizers 196 are also attached by welding, bolts, screws or other ways known to the trade.

The finish trimmer 170 is removably attached to the frame box 22 of the flooring material cutting device 20. The finish trimmer 170 can be attached to either the bottom right bar 28 or the bottom left bar 30 of the frame box 22, allowing the flooring material cutting device 20 to be customized for either right-handed or left-handed operators.

The finish trimmer 170 is attached to the frame box 22 by attaching the left arm 182 to the bottom right bar 28, to provide an orientation preferred by most right-handed operators. The left arm 182 can be attached to the bottom right bar 28 by welding, bolts, screws or other ways known to the trade.

To provide an orientation preferred by most left-handed operators, the right arm 188 of the finish trimmer 170 is attached to the bottom left bar 30 of the frame box 22, by welding, bolts, screws or other ways known to the trade.

In addition, a lower blunt blade 198 is provided. The lower blunt blade 198 has a front end 200 and a back end 202. If the finish trimmer 170 is attached to the bottom right bar 28 of the frame box 22, the lower blunt blade 198 is preferably attached to the left arm 182 of the lower blade base 172, so that the lower blunt blade 198 can more easily be replaced as it wears. The lower blunt blade 198 is preferably made from steel.

Alternatively, if the finish trimmer 170 is attached to the bottom left bar 30 of the frame box 22, then the lower blunt blade 198 is preferably attached to the right arm 188 of the lower blade base 172.

The lower blunt blade 198 is attached to either the left arm 182 or the right arm 188 of the lower blade base 172 by screws, so that it can be quickly replaced as it wears.

In addition, a space maintainer 204 is provided. The space maintainer 204 attaches between the back end 186 of the left arm 182 and the back end 192 of the right arm 188. The space maintainer 204 can be made of steel. It can be attached by welding, screws, bolts, pins or other ways known to the trade. The space maintainer 204 creates space between the left arm 182 and the right arm 188 of the lower blade base 172.

The finish trimmer 170 is further comprised of an upper blade base 206. The upper blade base 206 has a front end 208 and a back end 210. The upper blade base 206 is preferably made from steel. It can be attached to the lower blade base 172 by welding, screws, bolts or other ways known to the trade.

The upper blade base 206 has a stabilizer 212 attached to prevent warping of the finish trimmer 170 while pressure is being exerted upon it. The stabilizer 212 is preferably comprised of a sturdy material such as steel. The stabilizer 212 is attached to the upper blade base 206 by welding.

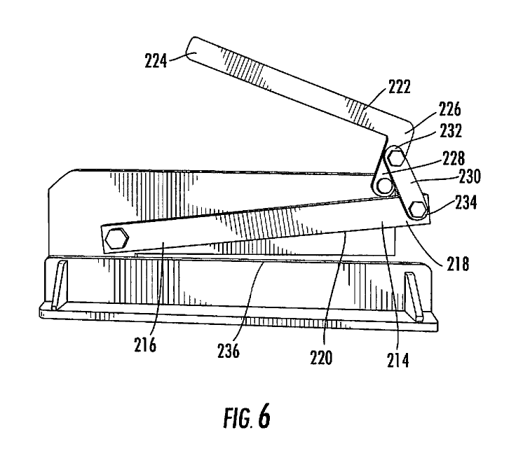

Referring to FIG. 6, the upper blade base 206 is further comprised of an upper bevelled blade 214. The upper bevelled blade 214 has a back end 216, a front end 218, as well as a bevelled side 220. The upper bevelled blade 214 is preferably comprised of steel. The upper bevelled blade 214 is attached to the upper blade base 206, such that the bevelled side 220 is oriented toward the lower blade base 172. The back 216 of the upper bevelled blade 214 attaches to the back 210 of the upper blade base 206 by screws, pins or other ways known to the trade, such that it can be easily removed and replaced as it wears. The front side 218 of the upper bevelled blade 214 extends past the front end 208 of the upper blade base 206.

The upper blade base 206 is additionally comprised of an L-shaped handle 222. The L-shaped handle 222 has a grasping end 224 for operating the finish trimmer 170, an elbow 226 and a short arm 228. The short arm 228 of the L-shaped handle 222 is attached to the front 208 of the upper blade base 206. The L-shaped handle is preferably made from a sturdy material such as steel or wood or other materials known to the trade.

In addition, the upper blade base 206 is comprised of a leveraging connector 230. The leveraging connector 230 has an upper end 232 and a lower end 234. The upper end 232 of the leveraging connector 230 attaches to the elbow 226 of the L-shaped handle 222. The lower end 234 of the leveraging connector 230 attaches to the front side 218 of the upper bevelled blade 214. The leveraging connector 230 is attached to the L-shaped handle 222 and the upper bevelled blade 214 by bolts, pins or screws such that when the L-shaped handle 222 is activated, the leveraging connector 230 can pivot while exerting force on the upper bevelled blade 214.

When a piece of flooring material is placed in the finish trimmer 170, it is oriented so that it rests upon the lower blade base 172 and the upper bevelled blade 214 is aligned with the portion of the flooring material to be cut. The L-shaped handle 222 is activated, causing the upper bevelled blade 214 to descend through the flooring material, against the lower blunt blade 198 and into the space created by the space maintainer 204. When the L-shaped handle 222 is returned to resting position, the cut flooring material is removed from the finish trimmer 170.

The finish trimmer 170 is used to complete cuts begun by the blade box 90, when the blade box 90 does not create a cut which continues to the edge of the flooring material, by extending those cuts. In addition, the finish trimmer 170 can cut flooring material into precise increments in horizontal, vertical or diagonal orientations.

In a preferred embodiment, measuring device 236 can be placed on the left arm 182 or right arm 188 of the lower blade base 172 to aid in orienting the flooring material in the finish trimmer 170.

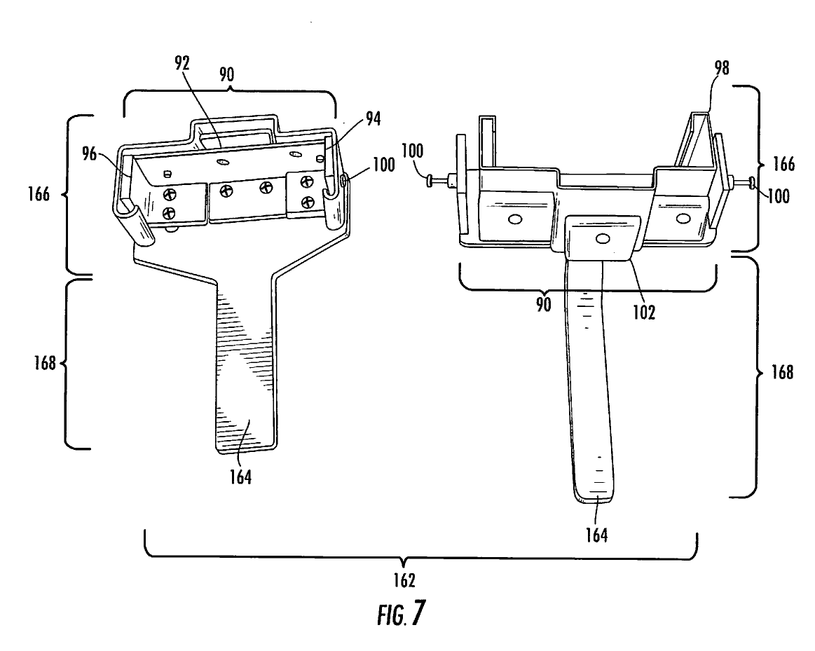

As seen in FIG. 7, in another embodiment, a hand-held cutting device 162 is provided, which is more easily transportable than the flooring material cutting device 20. The hand held cutting device 162 is comprised of a handle 164 and a blade box 90, which can be the same blade box 90 as is incorporated in the flooring material cutting device 20. The handle 164 has a blade box end 166 which is sized to accommodate the attachment of a blade box 90. Opposite the blade box end 166, the handle has a grasping end 168 provided for an operator to hold while engaging the hand held cutting device 162. The handle 164 is preferably made from steel, but can be made from wood, plastic or any material known to the trade.

Blade box 90 has a top blade box side 92, a right blade box side 94 and a left blade box side 96. The top, right and left blade box sides 92, 94, and 96 are attached together to form a receptacle for holding a blade 98. The blade box 90 is preferably made from steel, but can be made from other materials such as plastic or wood or other materials known to the trade. The blade box 90 is attached to the blade box end 166 of the handle 164 by welding. The blade box 90 can also be attached to the blade box end 166 of the handle 164 by screws, bolts, glue or other ways known to the trade. Alternatively, top, right and left blade box sides 92, 94, and 96 can be created from a single piece of material, such as by pouring plastic or metal into a mold or by carving the piece from a single block of wood or metal. In a further refinement of this embodiment, the handle 164 and the blade box 90 can be formed from a single piece of material, such as by pouring plastic or metal into a mold or by carving a single piece of wood or metal.

In another alternative, the top, right and left blade box sides 92, 94, and 96 can be separately attached to the blade box end 166 of the handle 164, maintaining the configuration required to hold a blade 98. In this embodiment, the top, right and left sides 92, 94, and 96 are not attached to each other, but are attached separately to the handle 164.

Once the handle 164 and the blade box 90 have been joined, the blade 98 is placed in the blade box 90 by blade attachments 100. Blade attachments 100 can be screws, bolts or other attachments known to the trade. A blade placement guide 102 can be provided in the top blade box side 92 to correctly position the blade 98 in the blade box 90. The blade placement guide 102 can be screws, brads or other materials known to the trade.

The hand-held cutting device 162 can be configured such that the blade box 90 can be rotated 180° on the handle 162. In this embodiment, the blade box 90 is not permanently attached to the blade box end 166 of the handle 164. The blade box 90 is loosened from the handle 164 and either twisted 180° on the handle 164 or completely removed from the blade box, turned and replaced, before tightening the blade box to the handle.

In order to use the flooring material cutting device 20, an operator first measures where a door frame cut will need to be made on a piece of flooring material. The operator then prepares the piece of flooring material according to the recommended industry practice. The operator then places the piece of flooring material into the cutting device 20, balancing it upon the base panel 104. Using the left measuring device 144, the right measuring device 146 and the adjustable measuring device 148, the operator quickly orients the piece of flooring material. The operator next engages the cam handle 88, causing the blade box 90 to depress into the flooring material, creating a cut whose shape exactly corresponds to the geometry of a door frame.

If the cut in the flooring material does not extend to the periphery of the piece, the flooring material can be placed into the finish trimmer 170, found on either the right or left side of the frame box 22. The piece of flooring material is aligned so that the lower blunt blade 198 is below the area which needs to be cut. The operator then engages the L-shaped handle 222, causing the upper beveled blade 214 to descend against the lower blunt blade 198, creating the desired cut in a single motion. The finish trimmer 170 can also be used to cut the flooring material into smaller pieces to fit into corners or around the perimeter of a room, quickly and easily making vertical, horizontal and diagonal cuts.

Alternatively, the operator may choose to use the hand held cutting device 162. The hand held cutting device 162 is used by positioning it over a piece of flooring material which has been prepared according to industry practices, with the blade 98 resting against the flooring material above where the desired cut should be. A heavy object, such as a hammer or mallet is then used to strike the blade box end 166, causing the blade to cut through the flooring material, creating a cut which, again, exactly corresponds to the geometry of a door frame.

The benefits of using the hand held cutting device 162 and the flooring material cutting device 20 include always producing an exact cut, which can fit around a door frame without having to add unsightly caulk to fill in any spaces. The exact fit has a more aesthetic appearance and allows the floor around the door frame to stay cleaner because dirt and debris does not collect into open seams on improperly fitting flooring material. The operator appreciates the devices 20 and 162 because they save time, creating a complex cut in a single motion, instead of having to take multiple measurements, transfer them to the piece of flooring material, then make multiple cuts. Both the flooring material cutting device 20 and the hand held cutting device 162 are safer to use because they do not require an operator to hold a heated piece of flooring material in one hand, while attempting to cut it with an open blade in the other.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A flooring material cutting device adapted to cut flooring material to fit around a door frame having a given geometry, the flooring material cutting device comprising:
a blade formed of a sharpened segment of material having the given geometry, the blade adapted to cut the flooring material, and
a handle secured to the blade, the handle adapted to position the blade adjacent the flooring material, and to receive force to move the blade through the flooring material, thereby cutting the flooring material.

2. The flooring material cutting device of claim 1 wherein the blade is a sharpened segment of a door frame.

3. The flooring material cutting device of claim 1 wherein the material is metal.

4. The flooring material cutting device of claim 1 wherein the material is ceramic.

5. The flooring material cutting device of claim 1, further comprising a blade box attached to the handle, wherein the blade box is adapted to securely hold the blade.

6. The flooring material cutting device of claim 5 wherein the blade box and the handle are comprised of a single piece of material.

7. The flooring material cutting device of claim 5 wherein the blade box is adapted to rotate 180 degrees so that it can provide a cut in a piece of flooring material to fit both a right and left side of a door frame.
